(19) United States
(12) Patent Application Publication
(10) Pub. No.: US 2009/0070397 A1
(43) Pub. Date: Mar. 12, 2009

(54) METHOD FOR ACTIVE NOISE REDUCTION AND AN APPARATUS FOR CARRYING OUT THE METHOD

(76) Inventor: Harry Bachmann, Stafa (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/574,447

(22) PCT Filed: Aug. 31, 2005
(86) PCT No.: PCT/CH2005/000510

§ 371 Date: Oct. 20, 2008

(30) Foreign Application Priority Data
Aug. 31, 2004 (CH) 1427/04

(51) Int. Cl. G06F 17/10

(52) U.S. Cl. 708/322; 702/191; 708/300

(57) ABSTRACT

In active noise reduction, at least one input signal (25) is fed to a computing unit (18), which passes on the at least one input signal (25) to at least one additional computing unit (19), wherein the at least one input signal (25) is processed for the generation of at least one output signal (26) in the at least one additional computing unit (19). Therein, a kind of processing for processing in the additional computing unit (19) is set by the computing unit (18). Finally, the generated at least one output signal (26) is fed to the computing unit (18). Furthermore, apparatuses for carrying out the method are disclosed.

The present invention relates to a method for active noise reduction according to the preamble of the claims 1 and 2 as well as apparatuses for carrying out the method.

Sources of noise are increasingly perceived as environmental pollution and considered as a reduction of quality of life. Since sources of noise are often not avoidable, methods for noise reduction have already been suggested, which base on the principle of wave canceling.

For example, noises which enter headphones of helicopter pilots are actively damped by making use of knowledge about noises which originate from the drive of the rotors. In big ventilation systems, the noises originating in the ventilation channels are often eliminated or reduced by means of such technologies.

The principle of active noise reduction is based on the cancellation of acoustic waves through interference. These interferences are generated by one or more electro acoustic converters, for example by loudspeakers. The signal emitted from the electro acoustic converters is calculated and continuously corrected by means of a suitable algorithm. As a basis for the signal to be emitted from the electro acoustical converters, information delivered from one or more sensors is used. On the one hand, this is information about the nature of the signals to be minimized. For this, for example, a microphone can be used, which records the noise to be minimized. On the other hand, nevertheless, information about the remaining residual signal is needed. For this too, microphones can be used.

The fundamental principle applied in active noise reduction has been described by Dr. Paul Lueg in the patent publication from 1935 and in the laying-open number AT-141 998 B. Through this publication, it is disclosed, how noise in a tube can be canceled. For this, the characteristic of the noise is recorded in advance by means of a microphone. In the tube, a loudspeaker is arranged in the direction of sound propagation. The signal recorded by the microphone is fed, in a time-delayed fashion, into the tube by means of a loudspeaker, wherein the time delay exactly corresponds to the propagating time of the signal between the microphone and the loudspeaker. The signal is, in addition, inverted before it is fed into the tube by means of the loudspeaker. The more precisely the time delay, the inversion and the amplitude are right, the better the noise contained in the tube will be minimized.

With the increasing proliferation of digital technologies, the way of proceeding in active noise reduction also changes. Whereas in the before-mentioned method of Lueg, the time shift and the amplitude had to be adjusted with much effort for obtaining as satisfactory result, mathematical models and algorithms resulting there from are today employed for achieving a noise reduction.

Currently, a multitude of publications concerning active noise reduction is available. The known teachings each aim in particular at a special adaptation and improvement, respectively, of the employed algorithms.

One object of the present invention consisted in pointing out a method for active noise reduction which allows for a fast execution of the employed algorithm, thus in pointing out a method which is characterized by a particularly high efficiency, showing a high flexibility at the same time.

This problem is solved in that at least one input signal is fed to a computing unit, in that, furthermore, the computing unit passes on the at least one input signal to at least one additional computing unit, in that, furthermore, the at least one input signal is processed in at least one additional computing unit for the generation of the at least one output signal, and in that, finally, the generated at least one output signal is fed to the computing unit. In addition, the manner of processing is set by the computing unit. Thus, the calculations in conjunction with the generation of the at least one output signal, which are prone to cause high efforts, can advantageously be transferred into the at least one additional computing unit. The computing unit receiving the input signal is therefore relieved from calculations of the output signal. Accordingly, the capacity of the computing unit can be used differently. The capacity of the computing unit can in particular be used for determining the most suitable algorithm, which is used for the calculation of the at least one output signal in the at least one additional computing unit.

In a specific embodiment of the present invention, it is foreseen that the processing of the at least one input signal consists in applying a digital filtering algorithm of the type FIR (Finite Impulse Response) or of the type IIR (Infinite Impulse Response) or of the type Lattice.

In a further embodiment of the present invention, it is foreseen that at least one of the following properties of the digital filter algorithm is provided by the computing unit:
at least one coefficient;
structure.

It is pointed out that this embodiment can be combined with one or more of the before-mentioned embodiments.

In an even more specific embodiment of the method according to the invention, the at least one coefficient and/or the structure are continuously adapted by calculations in the computing unit. In other words, the computing capacity of the computing unit is used for the continuous or even occasional adaptation of the algorithms used in the at least one additional computing unit. It is pointed out that this embodiment can be combined with one or more of the before-mentioned embodiments.

Finally, an even more specific embodiment of the method according to the invention consists in that the at least one input signal corresponds to an acoustic signal which can comprise noises, and in that the at least one output signal corresponds to another acoustic signal, which is used for the reduction of the noises. It is pointed out that this embodiment can be combined with one or more of the above-mentioned embodiments.

Furthermore, an apparatus according to the invention is described, which is suitable for carrying out the above-mentioned method according to one or more of the above-mentioned embodiments. The apparatus according to the invention is in particular characterized in that a computing unit with at least one input signal and with at least one output signal and at least one additional computing unit operationally connected to the computing unit is provided, and in that the at least one input signal can be processed in the at least one additional computing unit for generating the at least one output signal, wherein the kind of processing is set by the computing unit.

According to another embodiment of the apparatus according to the invention, the at least one generated output signal is fed to the computing unit.

An even further embodiment of the apparatus according to the invention is characterized in that the processing of the at least one input signal consists in that a digital filter algorithm of type FIR (Finite Impulse Response), of type IIR (Infinite Impulse Response) or of type Lattice is applicable.

An even further embodiment of the apparatus according to the invention consists in that at least one of the following properties of the digital filter algorithm is provided by the computing unit:
at least one coefficient;
structure.

It is pointed out that this embodiment can be combined with one or more of the before-mentioned embodiments.

An even further embodiment of the apparatus according to the invention consists in that the at least one coefficient and/or the structure are continuously adaptable. It is pointed out that this embodiment can be combined with one or more of the before-mentioned embodiments.

An even further embodiment of the apparatus according to the invention consists in
that the at least one input signal corresponds to an acoustic signal which can comprise noises, and
that the at least one output signal corresponds to another acoustic signal which is usable for the reduction of the noises.

It is pointed out that this embodiment can be combined with one or more of the above-mentioned embodiments.

An even further embodiment of the apparatus according to the invention consists in that the at least one input signal is operationally connected to a microphone, and that the at least one output signal is operationally connected to a loudspeaker unit. It is pointed out that this embodiment can be combined with one or more of the before-mentioned embodiments.

In the following, the present invention will be explained even further by means of specific embodiments referring to drawings. It is shown in

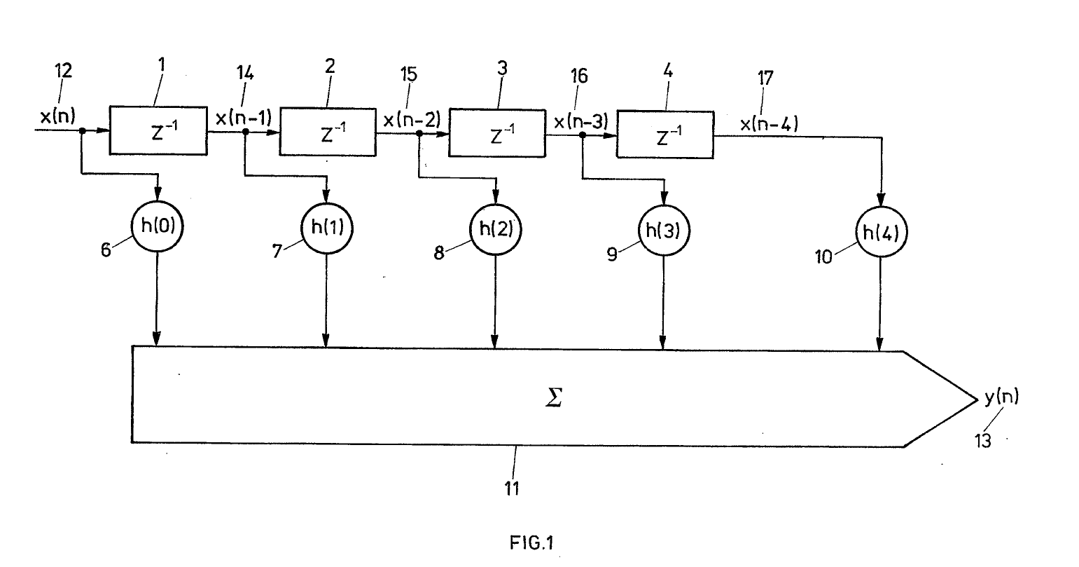

FIG. 1 a block diagram of a known FIR (Finite Impulse Response) filter,

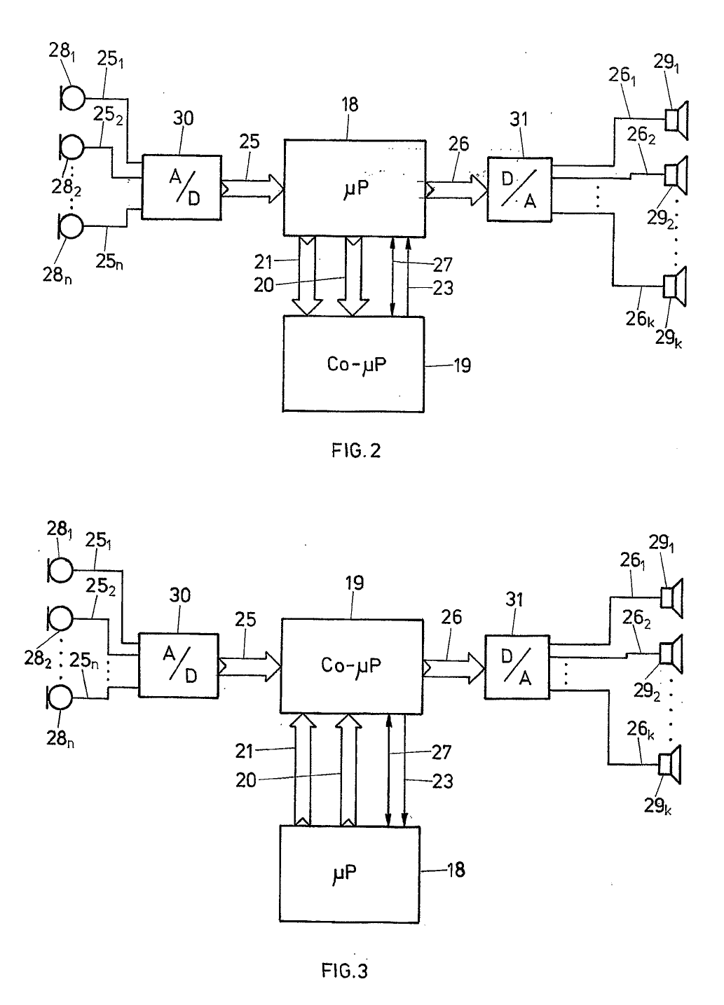

FIG. 2, schematically, a block diagram of an embodiment of an apparatus according to the invention, and

FIG. 3, schematically, a block diagram of another embodiment of an inventive apparatus.

FIG. 1 shows a block diagram of a known FIR (Finite Impulse Response) filter with four serially connected delay members 1 to 4. The first delay member 1 is provided with an input signal 12 with the value x(n) which is processed by the filter. The delay members 1 to 4 delay the input signal 12 and its value x(n), respectively, according to a given timing signal (not shown in FIG. 1), which is fed to the filter. Accordingly, the output signal 14 of the first delay member 1 is delayed by one clock. This is expressed in the commonly-used notation x(n-1) for the value of the output signal 14. Accordingly, the values of the output signals 15, 16 and 17 of the other delay members 2, 3 and 4 are given as x(n-2), x(n-3) and x(n-4).

By 6 to 10, coefficients of the filter are labeled, which have the values h(0), h(1), h(2), h(3) and h(4), respectively, and which are multiplied with the respective values x(n), x(n-1), x(n-2), x(n-3), x(n-4) for forming input signals for a summation unit 11. In the summation unit 11, the output signal 13 with the value y(n) is then formed.

There are also other structures for realizing digital filters; they have in common, however, that the computational effort increases with increasing number of coefficients. A multitude of applicable filters is described, e.g. in the publication having the title “The DSP Handbook” (Prentice Hall—ISBN 0 201 39851 6) by Andrew Bateman and Iain Paterson-Stephens.

The effort for calculating the values y(n) of the output signal depends on the length of the filter, i.e. of the number of coefficients. Corresponding to the filter length, more or less multiplications and additions are to be carried out, which are usually carried out by means of a digital signal processor (DSP) of known kind, which is specifically designed for this.

One possibility for minimizing the utilization of the signal processor consists in working on the calculation of the output value y(n) in an additional computing unit. Through this, the repetitive calculations typical for digital filters do not have to be carried out by the signal process itself anymore. In this case, the additional computing unit has a predefined characteristic, a predefined structure and a pre-described length. Usually, in such a case an FPGA (Field Programmable Gate Array) is employed. The disadvantage of this way of proceeding consists in that the coefficients as well as the structure of the digital filter cannot be changed.

FIG. 2 shows an apparatus for active noise reduction according to the present invention. The apparatus according to the invention consists of several microphones 25₁, 25₂ . . . , 25ₙ, an analog/digital converter unit 30, a computing unit 18, an additional computing unit 19, a digital/analog converter unit 31 and several electro-acoustic converters 29₁, 29₂, . . . , 29ₖ, which are also possibly referred to as loudspeakers.

As it has already been mentioned, acoustic signals are recorded for the active noise reduction; the recorded acoustic signals are at least in part reduced by the acoustic signals emitted by the loudspeakers. Therefore, the microphones 28₁, 28₂, . . . , 28ₙ are connected to the computing unit 18 via the analog/digital converter unit 30. The computing unit 18 passes on the input signal 25 received from the analog/digital converter unit 30 to the additional computing unit 19, in which a digital filter is used for the determination of the filter output signal, which is fed back to the computing unit 18 via a connection 23. Afterwards, the filter output signal 26 is passed on to the loudspeakers 29₁, 29₂, . . . , 29ₖ via the digital/analog converter unit 31. Accordingly, the entire filtering calculation is sourced out to the additional computation unit 19.

As additional computing unit 19, e.g., a conventional digital signal processor can be used, which is particularly suited for executing digital filter algorithms due to the parallel structure of the internal computing units.

The computing unit 18 does not carry out calculations in the context of the generation of the filter output signal as explained above. But the calculations in the computing unit 18 affect the algorithm employed in the additional computing unit 19. Thus, it is foreseen that the input signal 25 is analyzed in the computing unit 18, and that the digital filter is adjusted on the basis of the result of the analysis. This is done, for example, by adjusting the coefficients of the filter or by choosing the structure or the type of the filter. Accordingly, the computing unit 18 and the additional computing unit 19 are operationally connected by further channels. For example, the coefficients of the digital filter are each newly adjusted via a connection 20 between the computing unit 18 and the additional computing unit 19 and in dependence of decisions made in the computing unit 18. On the other hand, a control connection between the computing unit 18 and the additional computing unit 19 is provided, via which the filter structure used in the additional computing unit 19 is adjusted. This way, an extremely high quality adaptive filter is implementable, which additionally allows for a high computing power. Accordingly, the apparatus according to the invention is in particular greatly suited for active noise reduction. Nevertheless, the apparatus according to the invention can also be excellently applied in other technical areas.

In the following, the method according to the invention is described, in which an input signal x(n) is processed for generating an output signal y(n), wherein, according to the invention, the digital filter, i.e. the employed algorithm, has no pre-defined length and structure.

Following the explanations made in conjunction with FIG. 1, the coefficients, together with the values x to be calculated, are transmitted from the computing unit 18 to the additional computing unit 19. The latter, now, carries out the calculations for the number of the coefficients in parallel and sends the result back to the computing unit 18 via the connection 23. In the next cycle, the additional computing unit 19 receives, if applicable, the result finally calculated, together with the coefficients and the corresponding values. Therein, the length of the filter can be independent of the number of the transmitted coefficients.

Since the additional computing unit 19 solely multiplies the transmitted values x with the corresponding coefficients, and since neither structure nor length of the filter are therefore affected, an external digital filter with variable features can be realized in this way. Also the characteristic of the filter is not affected by the calculation taking place in the additional computing unit 19. Accordingly, this method can be applied for FIR-filters, IIR-filters as well as for filters with Lattice or grid structure, which means for the most widespread structures for digital filters.

FIG. 3 shows another embodiment according to the present invention. In contrast to the embodiment according to FIG. 2, the embodiment according to FIG. 3 consists in that the computing unit is interchanged with an additional computing unit. The signal flow from the microphones 28₁, 28₂, . . . , 28ₙ via the analog/digital converter unit 30 is now directed into the additional computing unit 19, which passes on the calculated output signal 26 via the digital/analog converter unit 31 to the loudspeakers 29₁, 29₂, . . . , 29ₖ. Still, the computing unit 18 is responsible for the determination and definition, respectively, of the coefficients of the filter and/or of the filter structure, as has been explained in conjunction with the embodiment according to FIG. 2.

1. Method for active noise reduction, in which at least one input signal (25) is processed for the generation of at least one output signal (26), characterized in
that the at least one input signal (25) is transmitted to a computing unit (18),
that the computing unit (18) passes on the at least one input signal (25) to at least one additional computing unit (19),
that at least one output signal (26) is generated by processing at least one of the input signals (25) in at least one additional computing unit (19), and
that a kind of processing in the additional computing unit (19) is set by the computing unit (18).

2. Method for active noise reduction, in which at least one input signal (25) is processed for the generation of at least one output signal (26), characterized in
that the at least one input signal (25) is fed to at least one additional computing unit (19),
that at least one output signal is generated by processing at least one of the input signals (25) in the additional computing unit (19), and
that the kind of processing in the additional computing unit (19) is set by the computing unit (18).

3. Method according to claim 1 or 2, characterized in that the processing of the at least one input signal (25) consists in that a digital filter algorithm of type FIR-Finite Impulse Response, of type IIR-Infinite Impulse Response or of type Lattice is applied.

4. Method according to claim 3, characterized in that at least one of the following properties of the digital filter algorithm is provided by the computing unit (18):
at least one coefficient;
structure.

5. Method according to claim 4, characterized in that the at least coefficient and/or the structure is continuously adapted through calculations in the computing unit (18).

6. Method according to one of the preceding claims, characterized in
that the at least one input signal (25) corresponds to an acoustical signal, which can comprise noises, and
that the at least one output signal (26) corresponds to an additional acoustic signal, which is used for the reduction of the noises.

7. Apparatus for carrying out the method according to one of the claims 1 to 6, characterized in that a computing unit (18) with at least one input signal (25) and with at least one output signal (26), as well as at least one additional computing unit operationally connected to the computing unit (18) are provided, and in that the at least one input signal (25) is process-able in the at least one additional computing unit (19) for the generation of the at least one output signal (26), wherein the kind of processing is set by the computing unit (18).

8. Apparatus for carrying out the method according to one of the claims 1 to 6, characterized in that an additional computing unit (19) with at least one input signal (25) and with at least one output signal (26), as well as at least one computing unit (18) operationally connected to the additional computing unit (19) are provided, and in that the at least one input signal (25) is process-able in the additional computing unit (19) for the generation of the at least one output signal (26), wherein the kind of processing is set by the at least one computing unit (18).

9. Apparatus according to claim 7 or 8, characterized in that the processing of the at least one input signal (25) consists in that a digital filtering algorithm of type FIR-Finite Impulse Response, of type IIR-Infinite Impulse Response or of type Lattice is applicable.

10. Apparatus according to claim 9, characterized in that at least one of the following properties of the digital filter algorithm is provided by the computing unit (18):
at least one coefficient;
structure.

11. Apparatus according to claim 10, characterized in that the at least one coefficient and/or the structure is continuously adaptable by the computing unit (18).

12. Apparatus according to one of the claims 7 to 11, characterized in
that the at least one input signal (25) corresponds to an acoustic signal, which can comprise noises, and
that the at least one output signal (26) corresponds to another acoustic signal, which is usable for the reduction of the noises.

13. Apparatus according to one of the claims 7 to 12, characterized in that the at least one input signal (25) is operationally connected to at least one microphone (28₁, 28₂, . . . , 28ₙ), and that the at least one output signal (26) is operationally connected to a loudspeaker unit (29₁, 29₂, . . . , 29ₖ).
